(19) United States
(12) Patent Application Publication
(10) Pub. No.: US 2005/0031173 A1
(43) Pub. Date: Feb. 10, 2005

(54) Systems and methods for detecting skin, eye region, and pupils

(76) Inventor: Kyungtae Hwang, Acton, MA (US)

Correspondence Address: DIGIMARC CORPORATION, 9405 SW GEMINI DRIVE, BEAVERTON, OR, 97008, US

(21) Appl. No.: 10/873,830

(22) Filed: Jun. 21, 2004

Related U.S. Application Data
(60) Provisional application No. 60/480,257, filed on Jun. 20, 2003.
(60) Provisional application No. 60/514,395, filed on Oct. 23, 2003.

(51) Int. Cl. G06K 9/00

(52) U.S. Cl. 382/118

(57) ABSTRACT

Systems, methods, and processes are provided for locating pupils in a portrait image for applications such as facial recognition, facial authentication, and manufacture of identification documents. One proposed method comprises three steps; skin detection, eye detection, and pupil detection. In the first step, the skin detection employs a plurality of Gaussian skin models. In the second step, coarse eye locations are found by using the amount of deviation in the R (red) channel with an image that has been cropped by skin detection. A small block centered at an obtained coarse location is then further processed in pupil detection. The step of pupil detection involves determining a Pupil Index that measures the characteristics of a pupil. Experiments tested on highly jpeg compressed images show that the algorithm of this embodiment successfully locates pupil images. It is believed that this novel technique for locating pupils in images can improve the accuracy of face recognition and/or face authentication.

### CROSS REFERENCE TO RELATED APPLICATIONS

This application claim priority to the following U.S. Provisional patent applications, each of which is hereby incorporated by reference in their entirety:
“Systems and Methods for Detecting Skin, Eye Region, and Pupils,” Ser. No. 60/480,257, Attorney Docket Number P0845D, filed Jun. 20, 2003, inventor Kyungtae Hwang; and
“Detecting Skin, Eye Region, and Pupils in the Presence of Eyeglasses,” Ser. No. 60/514,395, Attorney Docket Number P0903D, filed Oct. 23, 2004, inventor Kyungtae Hwang.

This application is also related to the following U.S. provisional and nonprovisional patent applications:
All in One Capture Station for Creating Identification Documents, Ser. No. 10/676,362, Attorney Docket No. P0885D, filed Sep. 30, 2003;
Enhanced Shadow Reduction System and Related Techniques for Digital Image Capture, Ser. No. 10/663,439, Attorney Docket No. P0883D, filed Sep. 15, 2003.

Systems and Methods for Managing and Detecting Fraud in Image Databases Used With Identification Documents (Application No. 10/723m240, Attorney Docket No. P0910D, filed Nov. 26, 2003—Inventors James V. Howard and Francis Frazier);
All In One Capture station for Creating Identification Documents (application Ser. No. 10/676,362, Attorney Docket No. P0885D, filed Sep. 30, 2003);
Systems and Methods for Recognition of Individuals Using Multiple Biometric Searches (application Ser. No. 10/686,005, Attorney Docket No. P0900D—Inventors James V. Howard and Francis Frazier); and
Multifunction All In One Capture Station for Creating Identification Documents (Application No. 60/564,820), filed Apr. 22, 2004.

Each of the above U.S. Patent documents is herein incorporated by reference in its entirety. The present invention is also related to U.S. patent application Ser. No. 09/747,735, filed Dec. 22, 2000, Ser. No. 09/602,313, filed Jun. 23, 2000, and Ser. No. 10/094,593, filed Mar. 6, 2002, U.S. Provisional Patent Application No. 60/358,321, filed Feb. 19, 2002, as well as U.S. Pat. No. 6,066,594. Each of the above U.S. Patent documents is herein incorporated by reference.

### FIELD OF THE INVENTION

Embodiments of the invention generally relate to devices, systems, and methods for detecting a human face and/or facial features such as eyes and skin of an individual in a digital image. Embodiments of the invention also relate to systems that can determine and/or verify the identity of a human face. Embodiments of the invention also relate to the creation of identification documents.

### BACKGROUND AND SUMMARY OF THE INVENTION

Identification Documents

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening, and prior to boarding their flight. In addition, because we live in an ever-evolving cashless society, ID documents are used to make payments, access an ATM, debit an account, or make a payment, etc.

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

In the production of images useful in the field of identification documentation, it is oftentimes desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

Identification documents, such as ID cards, having printed background security patterns, designs or logos and identification data personal to the card bearer have been known and are described, for example, in U.S. Pat. No. 3,758,970, issued Sep. 18, 1973 to M. Annenberg; in Great Britain Pat. No. 1,472,581, issued to G. A. O. Gesellschaft Fur Automation Und Organisation mbH, published Mar. 10, 1976; in International Patent Application PCT/GB82/00150, published Nov. 25, 1982 as Publication No. WO 82/04149; in U.S. Pat. No. 4,653,775, issued Mar.31, 1987 to T. Raphael, et al.; in U.S. Pat. No. 4,738,949, issued Apr. 19, 1988 to G. S. Sethi, et al.; and in U.S. Pat. No. 5,261,987, issued Nov. 16 1993 to J. W. Luening, et al. All of the aforementioned documents are hereby incorporated by reference.

Manufacture of Identification Documents

The advent of commercial apparatus (printers) for producing dye images by thermal transfer has made relatively commonplace the production of color prints from electronic data acquired by a video camera. In general, this is accomplished by the acquisition of digital image information (electronic signals) representative of the red, green and blue content of an original, using color filters or other known means. These signals are then utilized to print an image onto a data carrier. For example, information can be printed using a printer having a plurality of small heating elements (e.g., pins) for imagewise heating of each of a series of donor sheets (respectively, carrying sublimable cyan, magenta and yellow dye). The donor sheets are brought into contact with an image-receiving element (which can, for example, be a substrate) which has a layer for receiving the dyes transferred imagewise from the donor sheets. Thermal dye transfer methods as aforesaid are known and described, for example, in U.S. Pat. No. 4,621,271, issued Nov. 4, 1986 to S. Brownstein and U.S. Pat. No. 5,024,989, issued Jun. 18, 1991 to Y. H. Chiang, et al. Each of these patents is hereby incorporated by reference.

Commercial systems for issuing ID documents are of two main types, namely so-called “central” issue (CI), and so-called “on-the-spot” or “over-the-counter” (OTC) issue.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

Centrally issued identification documents can be produced from digitally stored information and generally comprise an opaque core material (also referred to as “substrate”), such as paper or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents. Another security advantage with centrally issued documents is that the security features and/or secured materials used to make those features are centrally located, reducing the chances of loss or theft (as compared to having secured materials dispersed over a wide number of “on the spot” locations).

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents are manufactured.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document.

OTC identification documents of the types mentioned above can take a number of forms, depending on cost and desired features. Some OTC ID documents comprise highly plasticized polyvinyl chloride (PVC), TESLIN, polycarbonate, or have a composite structure with polyester laminated to 0.5-2.0 mil (13-51 .mu.m) PVC film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the print head, holographic hot stamp foils (0.125-0.250 mil 3-6 .mu.m), or a clear polyester laminate (0.5-10 mil, 13-254 .mu.m) supporting common security features. These last two types of protective foil or laminate sometimes are applied at a laminating station separate from the print head. The choice of laminate dictates the degree of durability and security imparted to the system in protecting the image and other data.

Biometrics

Biometrics is a science that refers to technologies that can be used to measure and analyze physiological characteristics, such as eye retinas and irises, facial patterns, hand geometry, and fingerprints. Some biometrics technologies involve measurement and analysis of behavioral characteristics, such as voice patterns, signatures, and typing patterns. Because biometrics, especially physiological-based technologies, measures qualities that an individual usually cannot change, it can be especially effective for authentication and identification purposes.

Systems and methods are known that are capable of analyzing digital images and recognizing human faces. Extraction of facial feature information has been used for various applications such as in automated surveillance systems, monitoring systems, human interfaces to computers, systems that grant a person a privilege (e.g. a license to drive or a right to vote), systems that permit a person to conduct a financial transaction, television and video signal analysis. For example, commercial manufacturers, such as Identix Corp of Minnetonka, Minn. (which includes Visionics Corp.) manufacture biometric recognition systems that can be adapted to be capable of comparing two images, such as facial images or fingerprint images. The IDENTIX FACE IT product may be used to compare two facial images to determine whether the two images belong to the same person. Other commercial products are available that can compare two fingerprint images and determine whether the two images belong to the same person. For example, U.S. Pat. Nos. 6,072,894, 6,111,517, 6,185,316, 5,224,173, 5,450,504, and 5,991,429 further describe various types of biometrics systems, including facial recognition systems and fingerprint recognition systems, and these patents are hereby incorporated by reference in their entirety. Facial recognition has been deployed for applications such as surveillance and identity verification.

Some face recognition applications use a camera to capture one or more successive images of a subject, locate the subject's face in each image, and match the subject's face to a one or faces stored in a database of stored images. In some face recognition applications, the facial images in the database of stored images are stored as processed entities called templates. A template represents the preprocessing of an image (e.g., a facial image) to a predetermined machine readable format. Encoding the image as a template helps enable automated comparison between images. For example, in a given application, a video camera can capture the image of a given subject, perform processing necessary to convert the image to a template, then compare the template of the given subject to one or more stored templates in a database, to determine if the template of the subject can be matched to one or more stored templates.

In surveillance, for example, a given facial recognition system may be used to capture multiple images of a subject, create one or more templates based on these captured images, and compare the templates to a relatively limited “watch list” (e.g., set of stored templates), to determine if the subject's template matches any of the stored templates. In surveillance systems, outside human intervention may be needed at the time of enrolling the initial image for storage in the database, to evaluate each subject's image as it is captured and to assist the image capture process. Outside human intervention also may be needed during surveillance if a “match” is found between the template of a subject being screened and one or more of the stored templates.

In another example, some driver license systems include a large number of single images of individuals collected by so called “capture stations.” The capture stations include components that can capture an image of a person, and then, using circuitry, hardware, and/or software, process the image and then compare the image with stored images, if desired. When configured for face recognition applications, these identification systems can build template databases by processing each of the individual images collect at a capture station to provide a face recognition template thereby creating a template for every individual. A typical driver license system can include millions of images. The face recognition template databases are used to detect individuals attempting to obtain multiple licenses. Another application provides law enforcement agencies with an investigative tool. The recognition database can discover other identities of a known criminal or may help identify an unidentified decedent.

One important prerequisite to successful use of face recognition and/or face authentication systems is reliably and consistently locating a human face within an image. Known facial detection systems have used methods such as facial color tone detection, texture detection, eigenfaces, template matching, knowledge or rule-base systems, feature extraction, or edge detection approaches. These known systems still suffer from problems and inaccuracies and do not always successfully deal with variations in lighting conditions, rotation of the face, facial expressions, racial variations, etc.

Research continues to occur occurring in the area of automatic face detection based on skin color, including areas such as has discrimination between skin pixels and non-skin pixels through using various models. Because using skin color can be faster and more reliable for locating faces in images, improvements in the technology for detecting skin pixels are desirable.

In one embodiment, I provide a method for detecting a human face in an image. At least a portion of the skin of the human face in the image is detected. An eye region within the portion of the detected skin is defined. Pupils of the eyes are located within the eye region. The image can comprise a plurality of pixels, and the detection of skin can employ a plurality of Gaussian skin models. Each Gaussian skin model can detect a respective number of skin pixels in the image and/or can be associated with a respective range of skin tones.

In one embodiment, my method also masks the R channel with the number of skin pixels detected in the image. The masked R channel can be compared to a threshold, whereby if the masked R channel pixel is greater than the threshold the pixel is kept as detected skin and if the masked R channel pixel is less than the threshold (e.g., a threshold based on information in the image) the pixel is removed from the detected skin.

In one embodiment, the image comprises a plurality of pixels and I further define an eye region. I can find coarse eye locations (e.g., horizontal and vertical eye locations) in the eye regions. In one embodiment, I use standard deviation maps to help find horizontal and/or vertical eye locations.

In another aspect of the I invention, I provide a method of creating an image capable of being printed to an identification document, comprising:
capturing a digitized image of a subject;
locating a human face within the digitized image by:
   detecting at least a portion of the skin of the human face in the image;
   defining an eye region within the portion of the detected skin; and
   locating the pupils of the eyes within the eye region; and
determining, based upon the face location, how the human face should be positioned and sized within the digital image.

In still another aspect, I provide a system for locating the eyes in a digital image that contains an image of a face. The system comprises a plurality of Gaussian models, a selection subsystem, a cropping subsystem, means for determining candidates for horizontal eye locations, means for determining candidates for vertical eye locations, and means for selecting at least one eye location from the candidates. The plurality of Gaussian models are constructed and arranged to each detect at least one pixel in the digital image associated with a respective skin tone. The selection subsystem selects the Gaussian model that detected the most skin pixels to represent the skin in the digital image. The cropping subsystem selects a sub-portion of the digital image believed to contain the eyes.

The foregoing and other objects, aspects, features, and advantages of this invention will become even more apparent from the following description and drawings, and from the claims.

### BRIEF DESCRIPTION OF THE DRAWINGS

The advantages, features, and aspects of embodiments of the invention will be more fully understood in conjunction with the following detailed description and accompanying drawings, wherein:

FIG. 1 is a flowchart of a general method for locating pupils in a portrait image, in accordance with one embodiment of the invention;

FIG. 2 is a flowchart of a majority pixel detection method, in accordance with one embodiment of the invention;

FIGS. 3A through 3C are representations of illustrative histograms of light, red, and dark skin, respectively, in accordance with one embodiment of the invention;

FIG. 4 illustrates a two dimensional (2-D) joint Gaussian PDF, in accordance with one embodiment of the invention;

FIGS. 5A through 5D are representations of the testing of detection of pixels of an individual who has light color skin, where three different skin models and an enhancement process, respectively, were used for skin detection, in accordance with one embodiment of the invention;

FIG. 6 is a flowchart of a model selection process that can be adapted to be used as a means of classification of images, in accordance with one embodiment of the invention;

FIG. 7A illustrates a joint PDF in chrominance space for a light skin tone, in accordance with one embodiment of the invention;

FIG. 7B illustrates a joint PDF in chrominance space for a medium skin tone, in accordance with one embodiment of the invention;

FIG. 7C illustrates a joint PDF in chrominance space for a dark skin color in accordance with one embodiment of the invention;

FIG. 7D illustrates a combined joint PDF in chrominance space for skin color, in accordance with one embodiment of the invention;

FIG. 8A shows the pixels detected for a given image using a first color model, in accordance with one embodiment of the invention;

FIG. 8B shows the pixels detected for the same given image as FIG. 8A, but using a second color model, in accordance with one embodiment of the invention;

FIG. 9 is a flow chart of a general process for eye detection, in accordance with one embodiment of the invention;

FIGS. 10A-10C are illustrative examples showing an original image (FIG. 10A), detected skin (FIG. 10B), and a cropped image (FIG. 10C), as found using the methods of FIGS. 1-10, in accordance with one embodiment of the invention;

FIGS. 11A and 11B are illustrative images showing an original image (FIG. 11A) and the “red channel of the image (FIG. 11B), in accordance with one embodiment of the invention;

FIG. 11C shows the standard deviation map for the images of FIGS. 11A and 11B with a [2×2] window, in accordance with one embodiment of the invention;

FIG. 11D shows the horizontal profile calculated for the images of FIGS. 11A-11C, in accordance with one embodiment of the invention;

FIG. 12A is an illustration showing the combined Cr and Cb components of the cropped image of FIG. 11A, in accordance with one embodiment of the invention;

FIG. 12B is an illustration of the standard deviation map based on the combination of Cr and Cb channels of FIG. 12A;

FIG. 12C is a corresponding horizontal profile computed by adding the standard deviation values of FIG. 12B horizontally;

FIG. 13A illustrates a first eye location profile before filtering, accordance with one embodiment of the invention;

FIG. 13B illustrates the first eye location profile of FIG. 13A after a low pass filter is applied to eliminates narrow peak that generally are a lot smaller than the height of an eye;

FIG. 13C illustrates a second eye location profile before filtering, in accordance with one embodiment of the invention;

FIG. 13D illustrates the second eye location profile of FIG. 13C after a threshold filter is applied to eliminate small peaks, such as those caused by noise;

FIG. 13E illustrates a third eye location profile before filtering, in accordance with one embodiment of the invention;

FIG. 13F illustrates the third eye location profile of FIG. 13E after an “adjacent peaks” filter is applied;

FIG. 14A is an illustrative horizontal profile of a cropped portion of a facial image, in accordance with one embodiment of the invention;

FIG. 14B is the associated standard deviation map for the horizontal profile of FIG. 14A;

FIG. 15A shows vertical profiles (before filtering in blue, after filtering in red) for the cropped image of FIG. 11A;

FIG. 15B shows five corresponding candidates for vertical locations on a standard deviation map, for the cropped image of FIG. 11A;

FIG. 16 illustrates the five corresponding candidates for eye locations for the cropped image of FIG. 11A;

FIG. 17 is a flow chart of one embodiment of a method for locating pupils, in accordance with one embodiment of the invention;

FIG. 18A shows an original image (in which pupils are to be located), in accordance with one embodiment of the invention;

FIG. 18B shows pixel values at the left eye of the image of FIG. 18A;

FIG. 18C shows the fluctuation index computed for the image of FIGS. 18A and 18B;

FIG. 19 illustrates example locations for measurements for horizontal pupil index (PI), in accordance with one embodiment of the invention;

FIG. 20 is an illustrative example showing the slits for vertical pupil index, in accordance with one embodiment of the invention;

FIG. 21A is a first Gaussian probability detection function for pupil detection, in accordance with one embodiment of the invention;

FIG. 21B is second first Gaussian probability detection function for pupil detection, in accordance with one embodiment of the invention;

FIG. 22 is a flow chart illustrating a method for pupil selection in accordance with one embodiment of the invention; and

FIG. 23 is an illustrative example of a general-purpose computer system usable for implementing at least one embodiment of the invention.

Of course, the drawings are not necessarily drawn to scale, with emphasis rather being placed upon illustrating the principles of the invention. In the drawings, like reference numbers indicate like elements or steps. Further, throughout this application, certain indicia, information, identification documents, data, etc., may be shown as having a particular cross sectional shape (e.g., rectangular) but that is provided by way of example and illustration only and is not limiting, nor is the shape intended to represent the actual resultant cross sectional shape that occurs during manufacturing of identification documents.

### DETAILED DESCRIPTION OF THE INVENTION

Overview

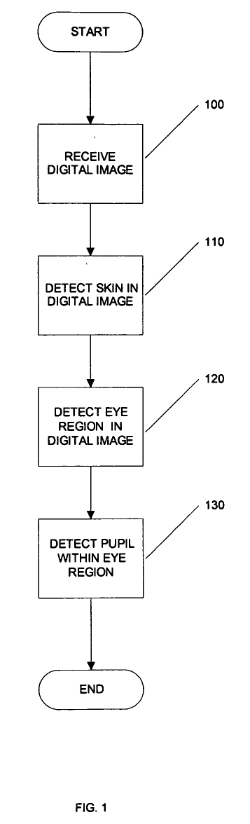

In one embodiment, this patent application presents novel systems and methods that utilize a process for locating pupils in a portrait image for applications such as facial recognition, facial authentication, and manufacture of identification and other security documents. A general overview of one embodiment of a method in accordance with the invention is shown in FIG. 1. The proposed method comprises three general steps: skin detection, eye detection, and pupil detection. After receiving a digital image (step 100), a skin detection step (step 110) employs one or more single Gaussian skin models to detect skin in the received digital image. In step 120, coarse eye locations are found by using the amount of deviation in the R (red) channel with an image that has been cropped by skin detection. A small block centered at an obtained coarse location is then further processed in pupil detection (step 130). The step of pupil detection also involves determining a Pupil Index that measures the characteristics of a pupil. Experiments tested on highly jpeg compressed images show that the method of this embodiment successfully locates pupil images. It is believed that this novel technique for locating pupils in images can improve the accuracy of face recognition and/or face authentication.

In at least one embodiment, systems and methods implementing the invention can be used as part of a system for capturing images and/or creating identification documents, such as driver's license. Such a system includes a camera or other equipment capable of capturing the image of a person. The camera can be any type of camera capable of producing an image of a person's face, including a video camera, digital camera, analog camera, and the like. In drivers license systems provided by the assignee of the present invention, the system includes a “capture station” that includes components (e.g., camera, strobe, shadow reduction devices, controls, etc.) capable of capturing the image of a person, and then, using circuitry, hardware, and/or software, process the image for printing onto the identification document, for storage in a database of images, and/or for comparison with previously stored images (for purposes of identification and/or authentication, e.g.). The system can also include equipment for printing and/or manufacturing an identification document, such as inkjet or laser printers, laminators, die cutters, as will be readily understood by those skilled in the art.

In one aspect, the invention can be used as part of a system that performs some or all of the following functions:
capturing an image of a subject;
converting the captured image to a digitized image, if necessary (e.g., by scanning);
locating a human face within the digitized image (using some or all of the methods described herein);
evaluating one or more aspects of the found human face in the image;
determining, based upon this face location and evaluation work, how the system should position the human face in the center of the digital image;
adjusting the gamma level of the image, and provide contrast, color correction and color calibration and other related adjustments and enhancements to the image;
generating instructions for a printer to be able to produce an identification card containing a photographic image of the face of the subject, wherein the subject's face is of a consistent size in the photographic image, has consistent placement in the photographic image and is generally aesthetically pleasing;
saving a copy of the photographic image and/or the initially captured digitized image in a database of images;
creating one or more searchable biometric templates based on the found human face in the image;
searching a database of biometric templates using the biometric template of the subject created in step (i) using a biometric search engine (e.g., a face recognition engine or an iris recognition engine) to determine whether there are other images of the subject (or persons who appear to resemble the subject) in the database of images;
determine, based on the results of the search in step (j), whether or not the subject will be issued and/or permitted to keep an identification card; and/or
determining, based on the results of the search in step (j), whether further investigations of the subject may be necessary.

Overview of Skin Detection

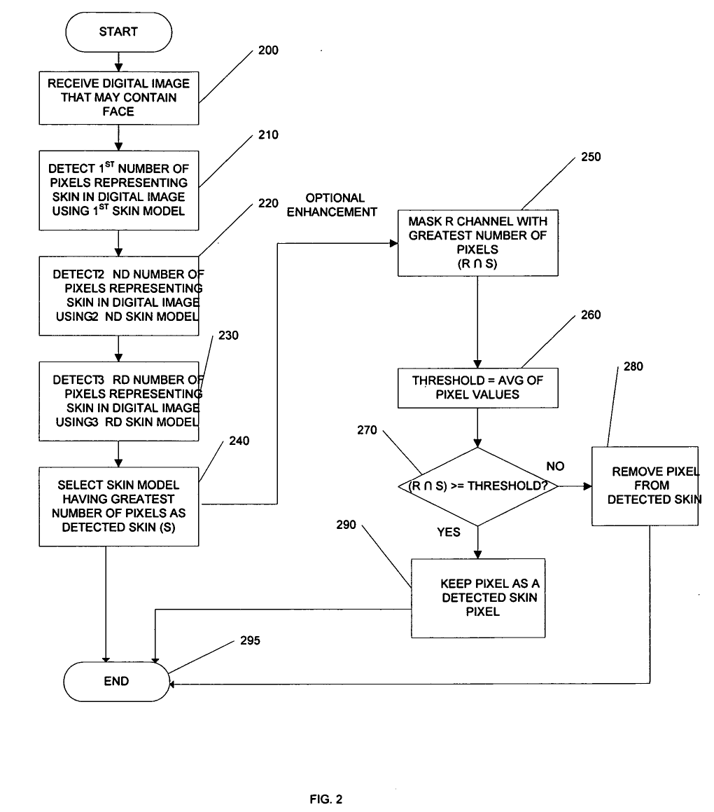

Referring again to FIG. 1, in the skin detection step (step 110), a face area is first located by skin detection that employs skin color models based on single Gaussian model in normalized R-G spaces. Three skin color models that differ in skin tone are created: light, medium and dark. A model (light, medium, or dark) for a particular facial image is automatically chosen based on a majority pixel detection method, as shown in the method of FIG. 2.

With a majority pixel detection method as described herein, the resultant model that is selected is the one that extracts the most skin pixels from the image. In a further embodiment, because this method may sometimes capture non-skin pixels (such as pixels corresponding to skin-like hair and clothes), the skin pixels are filtered with a threshold derived from an average of skin pixels. A flowchart illustrating one embodiment of this method is shown in FIG. 2. The steps of this flowchart are referred to further below.

Skin Color Model

Skin detection segments skin area in order to reduce Region of Interest (ROI) for the next step, eye region detection. It employs skin color models that are based on 2 dimensional Joint Gaussian Probability Density Function (PDF) expressed in the following Equation 1:

$$P ( X ) = \frac{1}{2 π \sqrt{Det ( M )}} exp ( - \frac{( X - m ) * {M}^{- 1} * ( X - m )}{2} ) \qquad ( 1 )$$

, where m and M are average and covariance matrix of normalized R and G channel (Chrominance Space) respectively.

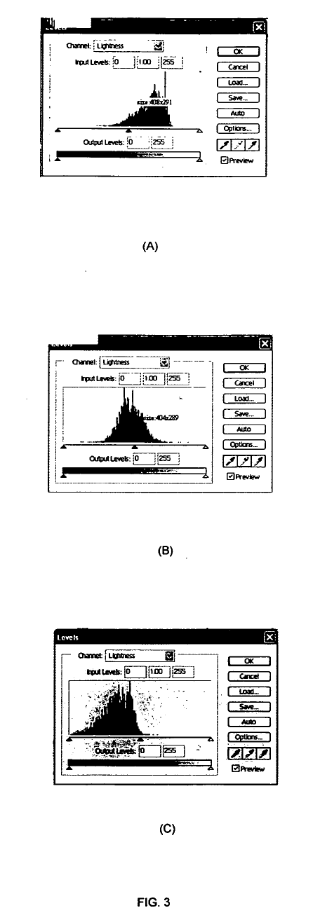

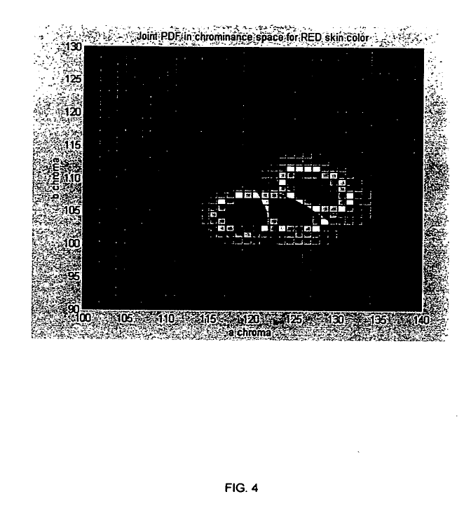

Three skin color models were built with samples that were chosen from a large set of highly jpeg compressed facial images. Those samples are categorized into 3 classes (light, red and dark) by examining the histogram of skin area. FIGS. 3(A) through (C) show representations of three illustrative skin histograms: (A) light, (B), red, and (C) dark. Each of the three classes was used to build a corresponding skin color model. FIG. 4 illustrates a two dimensional (2-D) joint Gaussian PDF of three color models derived by above Equation 1 above.

Model Selection Scheme

One possible limitation of using a skin color model is that it can be difficult for a single model to adequately cover many different skin tones. For example, a model for dark color may not properly select skin pixels for light skin tone. The affects of this limitation can be minimized by selecting the best model for a particular face image. For example, a simple scheme may be based on majority pixel detection. With that scheme, a model is selected if such a model extracts skin pixels most. Referring again to FIG. 2, steps 200 through 240 are a simplified view of the steps of a majority detection process.

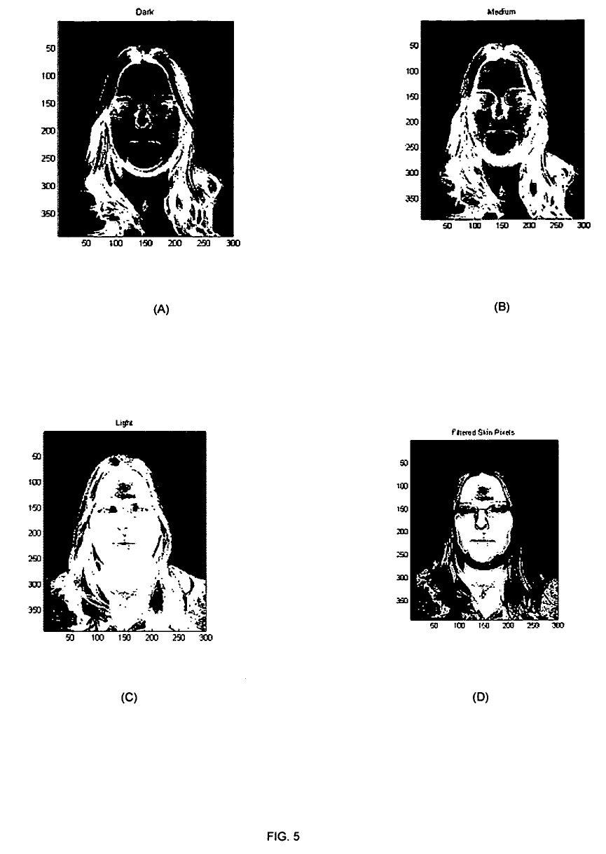

FIGS. 5A through 5D are representations of the testing of detection of pixels of an individual (original image not shown) who has light skin tone, where three different skin models and an enhancement process, respectively, were used for skin detection. This would correspond to the first, second, and third models of steps 210, 220, and 230, respectively, of FIG. 2 and the enhancement process (steps 250-290 ) of FIG. 2. Referring to FIGS. 2 and 5, FIG. 5A shows skin detection using a dark model. FIG. 5B shows skin detection using a medium model. FIG. 5C shows skin detection using a light model. The numbers of detected pixels are 24726 with dark model (FIG. 5A), 35999 with medium model (FIG. 5B), and 54513 with light model (FIG. 5C). Step 240 of FIG. 2 selects the skin model having the largest number of pixels to be detected skin S. In this example, that model is the skin detection of FIG. 5C. Thus, the test results of FIGS. 5A through 5C indicate that, at least in this example, a light color model was the best for light color skin.

Enhanced Skin Detection Process

The majority-based skin selection scheme can have a limitation in that it may sometimes also capture skin-like hair and clothes. For example, FIG. 5C shows that portions of hair and clothes were also selected as “skin” along with real skin. Thus, as referenced n FIG. 2, in at least some embodiments of the invention, optional enhancement steps 250 through 290 (referred to herein as the “enhanced skin detection process” can be performed to help reduce those errors caused by skin-like objects.

Referring to FIG. 2, the enhanced skin detection process employs an R channel to refine skin pixels. The R channel is first masked with detected skin S (corresponding to the greatest number of skin pixels) (step 250 ). The average of pixel values is computed as a threshold value (step 260). Pixels that are below that threshold then removed from detected skin (steps 270 and 280) and pixels at or above it are kept (step 290). FIG. 5D shows the image of FIG. 5C after going through the enhanced skin detection process of steps 250-290 of FIG. 2. Compared with the image of FIG. 5C, the image of FIG. 5D, shows numerous non-skin pixels are removed by using the enhanced process of FIG. 2.

Building an Improved Skin Color Model

The aforementioned skin color models were built using selected image samples that were classified by examining both a histogram of manually-selected skin areas in a luminance channel and visual skin color. In some instances, it is believed that some relatively poor classifications may have occurred because of inconsistency of color tone, poor quality, etc. This misclassification can sometimes result in poor color skin models.

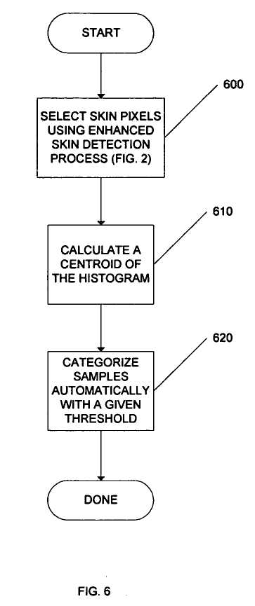

To improve the accuracy of the skin models, models, the above-described enhanced model selection process can be adapted to be used as a means of classification of images. FIG. 6 is a flow chart of this process. Skin pixels are selected using the enhanced skin detection process of FIG. 2 (step 600). From these selected pixels, a centroid of the histogram is calculated (step 610). The samples are then categorized (preferably automatically) with a given predetermined threshold.

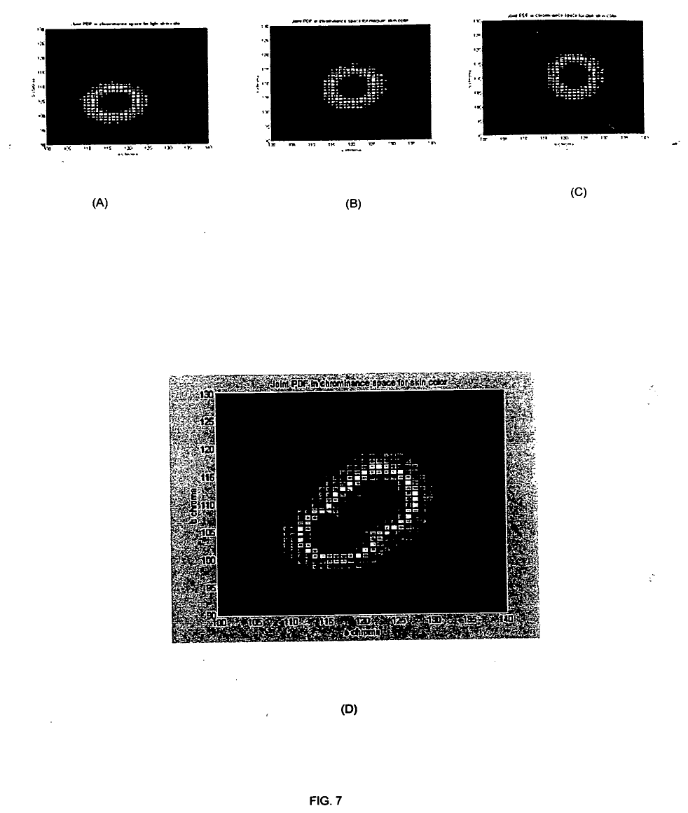

Using a set of sample photographic portrait images (which sample set included images of varying skin tones, I computed new skin models for light, medium, and dark skin tones, and a combined skin model. FIGS. 7A-7D are illustrative examples of the joint PDFs of these new skin models. FIG. 7A illustrates a joint PDF (Equation 1) in chrominance space for a light skin tone. FIG. 7B illustrates a joint PDF in chrominance space for a medium skin tone. FIG. 7C illustrates a joint PDF in chrominance space for a dark skin tone. FIG. 7D illustrates a combined joint PDF in chrominance space for skin color.

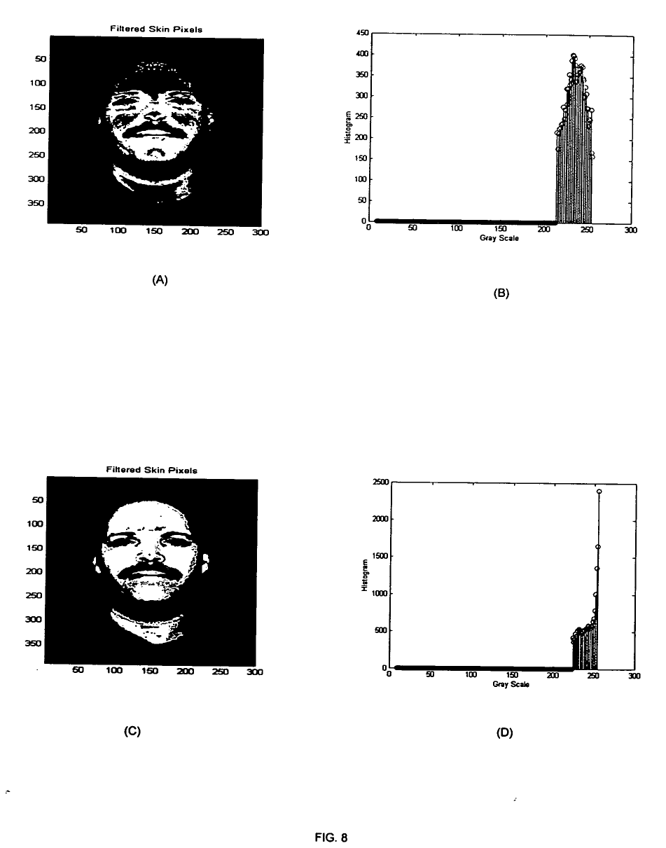

Using the enhanced skin color models of FIGS. 7A-D, additional testing was done of representative images to compare existing and enhanced color models. For example, for a given light colored skin image, the threshold for the existing color model was set to 180. FIG. 8A shows the pixels detected using the existing color model; in FIG. 8A, 12602 skin pixels were detected. The histogram of FIG. 8B shows pixels above the threshold of 180. For the histogram of FIG. 8B, the start value was 214, and a centroid was computed to be at 235. FIG. 8C shows the pixels detected for the same given light toned skin image. In FIG. 8B, the threshold for the enhanced color model was set to 210, and this model detected 21210 skin pixels. FIG. 8D is the histogram corresponding to FIG. 8C. The histogram of FIG. 8D shows a start value of 223 and a centroid of 243.

The results of FIG. 8A-8D show that the number of detected skin pixels increased 40% (from 12602 to 21210) using a new (enhanced) color model for this image. The results and improvement shown by FIGS. 8A-8D can be achieved as well with other skin, as will be appreciated by those of skill in the art.

Eye Detection

Referring again to FIG. 1, another step in the pupil detection process is detecting the eyes and/or the eye region (step 120). One purpose of this step is to calculate the coarse eye locations. The horizontal and vertical profiles that are computed from the standard deviation map, indicates location of eye regions as well as eye-like objects. Those locations are further processed in the next step, pupil detection (step 130 of FIG. 1).

Brief Overview of Eye Detection

In the eye detection step (which is further described below), the facial image is first cropped by selecting the upper part of the detected skin region (the detected skin region can, for example, be the skin pixels extracted during the “skin detection” step described above). The coarse eye locations are then obtained using horizontal and vertical profiles that are computed from the standard deviation map. Due to a large deviation of pixel values around the eye region, the horizontal profile can be calculated by adding deviation values horizontally. Using this calculation, horizontal eye locations can be found by looking for peak locations

Once the horizontal location is found, the vertical profile is computed within a band, where its horizontal center is the obtained horizontal eye location. This computation utilizes essentially the same method as did the horizontal profile, except that the orientation of adding the deviation values changes and also takes into account a few parameters accounting for shorter selected region (band) and width/height ratio of eye. Then, the horizontal eye locations are replaced with a pixel that has the highest average value in a small block. Both horizontal and vertical profiles involve filtering operations that eliminate unwanted peaks.

Eye Detection as Implemented in one Embodiment of the Invention

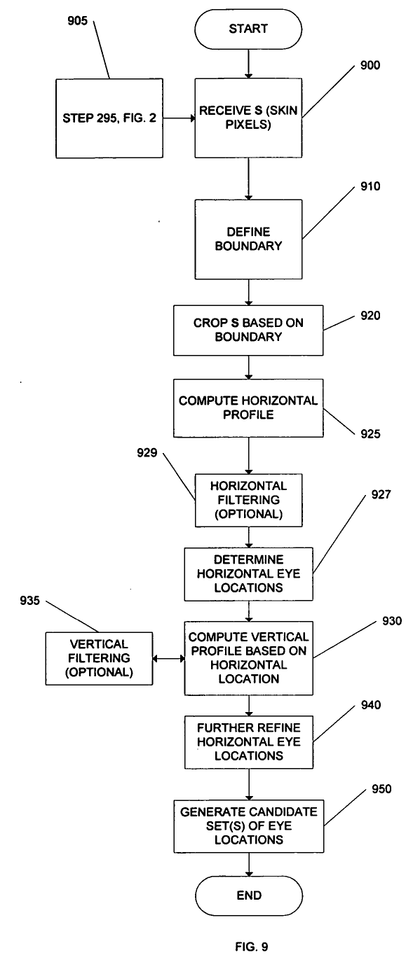

FIG. 9 is a flow chart of a general process for eye detection, in accordance with one embodiment of the invention. A face area is first located by skin detection and received as skin pixels S (step 900). The face area is then cropped in such a way that the size of image is as small as possible and eyes are included in that image (steps 910, 920). As those skilled in the art will appreciate, many different types of boundaries can be defined to include an area of interest.

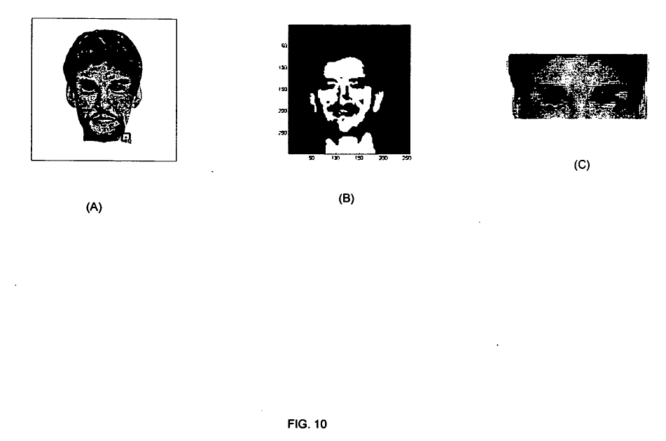

FIGS. 10A-10C are illustrative examples showing an original image (FIG. 10A), detected skin (FIG. 10B), and a cropped image (FIG. 10C), as found using the methods of FIGS. 1-10, in accordance with one embodiment of the invention.

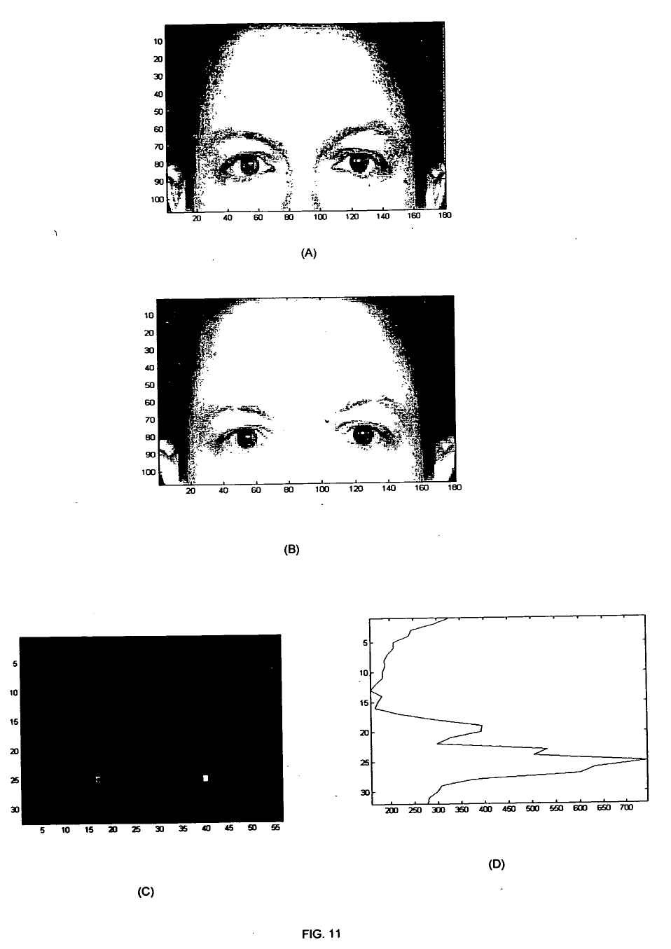

Referring again to FIG. 9, the cropped image (step 920) is used for detecting candidate eye locations (e.g., possible horizontal and vertical eye locations). In this example implementation, horizontal eye locations are determined first (steps 925-929). During my testing of images, I noted that pixel values of skin in a “Red” (R) channel can tend to be large, while those of eyes are small. This is shown in FIG. 11A (an original image) and FIG. 11B (the R channel of FIG. 11A).

Such differences in pixel value generate a large standard deviation between pixels. FIG. 11C shows the standard deviation map for the images of FIGS. 11A and B with a [2×2] window. FIG. 11C clearly shows that higher deviation can be obtained around the area. Thus, a horizontal profile (FIG. 1I D) can be calculated by adding deviation values horizontally. I have found that other “border” type areas (e.g., areas such as the border between hair and skin, or the border between a background and hair (or skin) also can tend to have a large standard deviation between pixels.

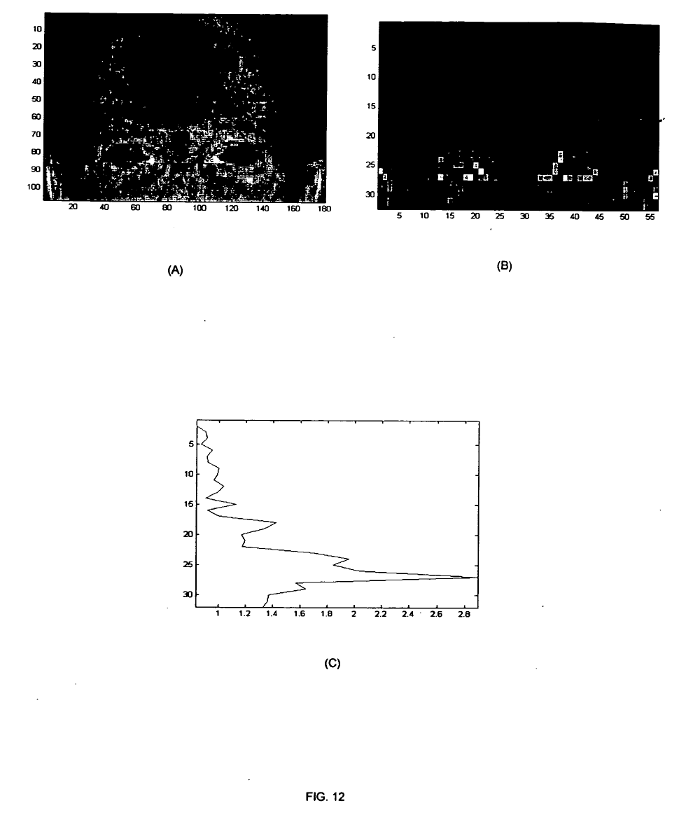

Another aspect of the cropped image that provides information useful for estimating horizontal eye locations is the chrominance component of the image. I have found that the red chrominance (Cr) and blue chrominance (Cb) components provide enough information to estimate horizontal eye locations. FIG. 12A is an illustration showing the combined Cr and Cb components of the cropped image of FIG. 11A. FIG. 12B is an illustration of the standard deviation map based on the combination of Cr and Cb channels of FIG. 12A. FIG. 12C is a corresponding horizontal profile computed by adding the standard deviation values of FIG. 12B horizontally. Note that proper combination of two channels provides features to obtain horizontal as well as vertical location of eyes (step 930). In at least one embodiment, however, I have found it advantageous to use only the R channel because of high jpeg compression.

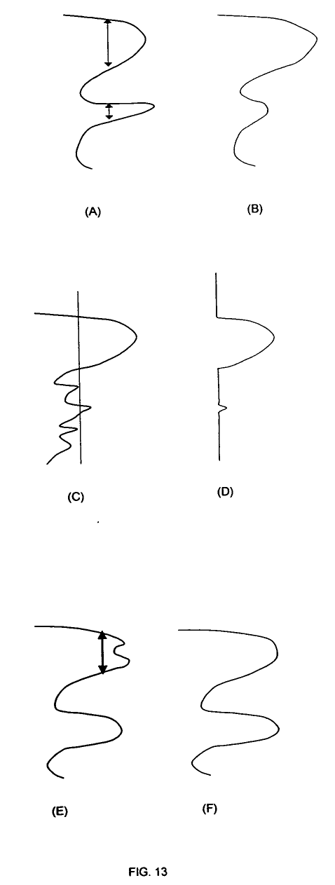

In some embodiments of the invention, I use filtering (steps 929) to help reduce and/or simplify computations and to help reduce false eye indication. FIGS. 13A-13F are illustrative examples showing illustrative examples of eye location profiles before and after filtering, in accordance with one embodiment of the invention.

FIG. 13A illustrates a first eye location profile before filtering, and FIG. 13B illustrates the first eye location profile of FIG. 13A after a low pass filter is applied to eliminates narrow peak that generally are a lot smaller than the height of an eye. One common cause of such narrow peaks can be features such as eyebrows. In one embodiment, the low pass filter implementation employs a moving average as a low pass filter. I have found that the filter length should be carefully chosen depending on the resolution and the size of the image.

FIG. 13C illustrates a second eye location profile before filtering and FIG. 13D illustrates the second eye location profile of FIG. 13C after a threshold filter is applied to eliminate small peaks, such as those caused by noise. Eliminating such small peaks can be useful to reduce computational cost. In one implementation, I used the following equation (Equation 2) to select the peaks to be eliminated:
Peak value>max(profile)*ratio+min(minima) (2)

FIG. 13E illustrates a third eye location profile before filtering and FIG. 13F illustrates the third eye location profile of FIG. 13E after an “adjacent peaks” filter is applied. For adjacent peaks, if two adjacent peaks are located closely within the height of the eye, I have found that one can remove one of the points.

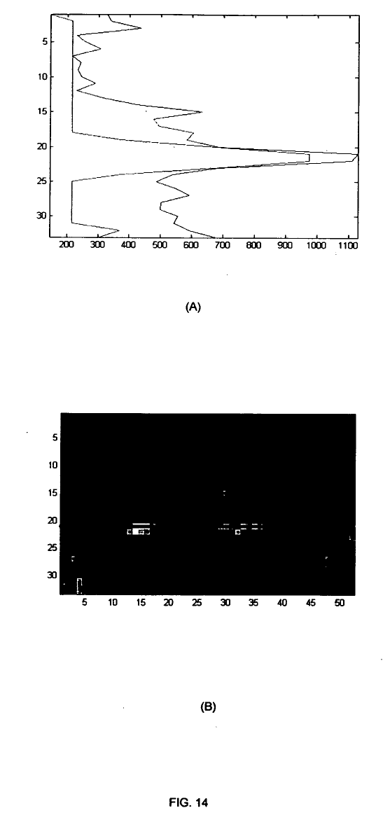

Further examples of how filtering helps threshold filter is applied to a horizontal profile and standard deviation map can be seen in FIGS. 14A and 14B. FIG. 14A is an illustrative horizontal profile of a cropped portion of a facial image, in accordance with one embodiment of the invention, and FIG. 14B is the associated standard deviation map for the horizontal profile of FIG. 14A. In FIG. 14A, the blue and red lines represent the profile before and after filtering, respectively. In FIG. 14B, the blue line on the image shows the location of eyes on the standard deviation map.

Subsequently, a peak location is calculated as a candidate for the horizontal location of eyes. In case of multiple peaks, all peaks are considered as candidates.

Referring again to FIG. 9, once candidates for the horizontal locations of the eyes are found (steps 925-929), the vertical location of the eyes is determined (step 930). The vertical profile of the eyes is computed within a band, where its horizontal center is the horizontal eye location. In one embodiment, the computation of the vertical profile uses the same method as used to compute the horizontal profile. However, because the size of the processed region (band) is smaller, and because I am assuming that the width of an eye is larger than the height of an eye, certain parameters (e.g., filtering) may be adjusted.

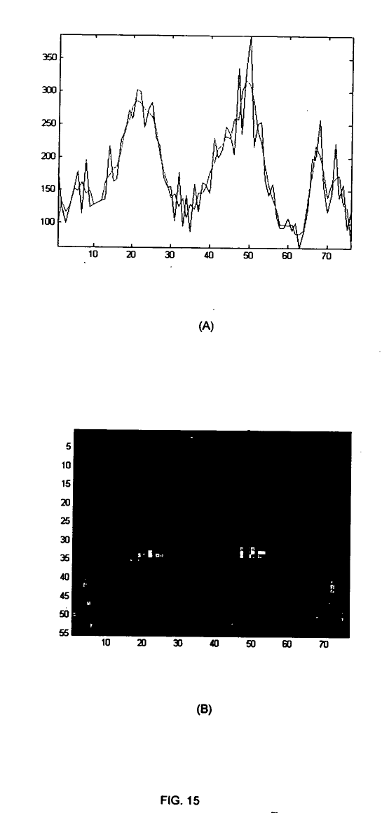

FIG. 15A shows vertical profiles (before filtering in blue, after filtering in red) and FIG. 15B shows five corresponding candidates for vertical locations on a standard deviation map, for the cropped image of FIG. 11A.

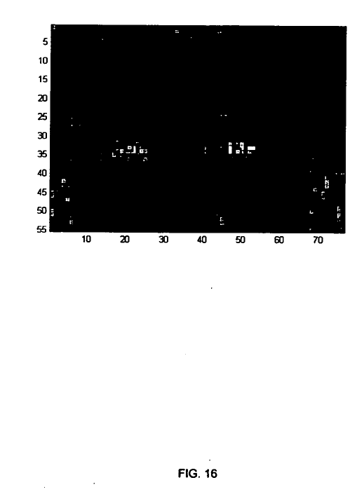

Referring again to FIG. 9, given vertical locations (step 930), the horizontal eye locations are refined within a band (step 940). In this step, the horizontal location of highest pixel value along the vertical line scan (e.g., FIGS. 15A and 15B) is set to be the eye location. When this step is applied to the five candidates for vertical locations of FIG. 15B, five corresponding candidates for eye locations result (step 950). An illustrative example of the five corresponding candidates for eye locations is shown in red in FIG. 16.

Note that in the above examples, the invention is not limited to five candidates for eye locations (or any other number). As those skilled in the art will appreciate, the actual n umber of candidates for eye locations depends on the horizontal and/or vertical candidates located in the previous steps, the quality of the image, etc., etc. There may be zero candidates, one or two, more than five, etc.

Pupil Detection

General Overview of Pupil Detection

In this step, which is further explained below, a precise pupil location is calculated within a block, where the center of block is the coarse location obtained at the previous step (eye detection). For each horizontal line in a block, a fluctuation index that measures the fluctuation and signal strength is calculated. For a typical eye, the high fluctuation index occurs at the pupil. At each peak on selected lines with high fluctuation index, a Pupil Index (PI) is calculated by measuring the characteristics of pupil including slope, height, and pixel value relative to upper and lower neighbors. Subsequently, a point with maximum PI is selected. This point represents a pupil candidate in a block. If there are more than two pupil candidates (i.e. two blocks), a pupil selection scheme is employed, which involves Ratios of Pupil Index. Those Ratios are calculated with three highest PIs (x₁, x₂, x₃, where x₁≧x₂≧x₃) as follows.

Secondary Ratio (R₂) represents the distance between top two PIs and the third. If the value of x₁ and x₂ are close and significantly larger than x₃, R₂ is very small. In this case, there is a high probability that both locations of x₁ and x₂ are real pupils.

First Primary Ratio (R₁₁) represents the distance between x₁ and x₂. If R₁₁ is significantly large, x₁ is most likely a pupil.

Secondary Primary Ratio (R₁₂) that represents the distance between x₂ and x₃, is used for further processing to select the second pupil after x₁ is selected.

In the situation where Pupil Index Ratios are not clear to distinguish two pupils, geometric rules may be applied.

Pupil Detection as Implemented in one Embodiment of the Invention

Referring briefly back to FIG. 1, the third step after detecting skin and detecting the eye region is to detect the pupil within the eye region. At this third step, precise pupil locations are calculated within a block centered by an eye location obtained at the previous (second) step (step 120).

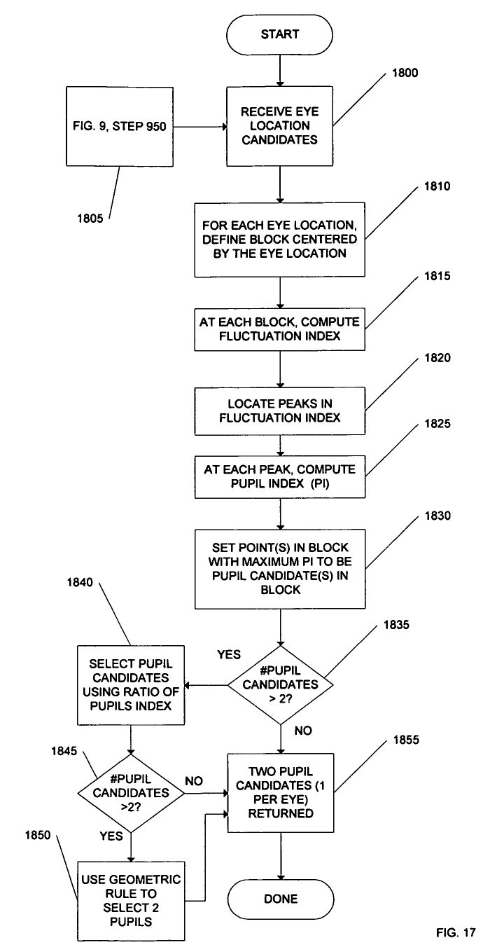

FIG. 17 is a flow chart of one embodiment of a method for locating pupils, in accordance with one embodiment of the invention. After eye location candidates are received (steps 1800 and 1805), for each eye location, a block is defined that is centered by the eye location (step 1810). At each block, a fluctuation index Fⱼ is computed. In one embodiment, the fluctuation index is measured as shown below in equation 3:

$${F}_{j} = {\sum }_{i}^{} {( ▽ - μ ( ▽ ) )}^{2} \qquad ( 3 )$$

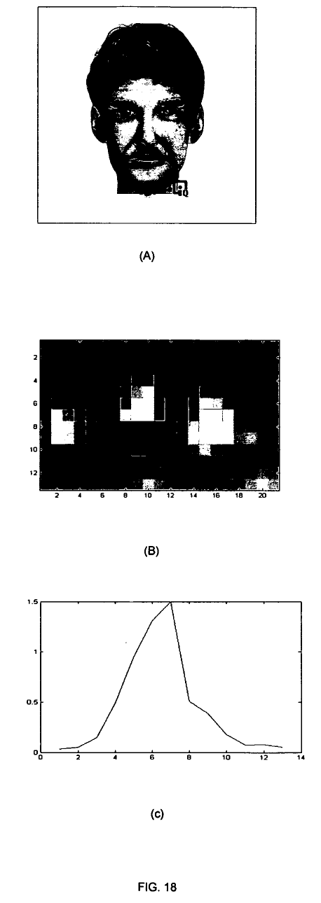

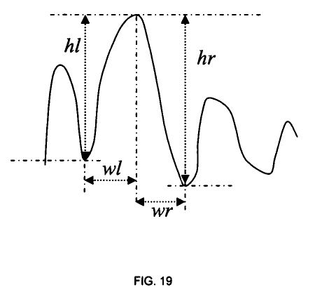

In Equation (3) above, i,j, ∇, and μ represent column index, row index, the first derivative of pixel value, and average of pixel value respectively. I have found that the highest fluctuation index in a typical eye occurs at the center of the pupil. A first example of is shown in FIG. 19. FIG. 18A shows the original image (in which pupils are to be located), FIG. 18B shows pixel values at the left eye of the image of FIG. 18A, and FIG. 18C shows the fluctuation index as computed using Equation 3. Because the highest fluctuation index occurs at the center of a pupil, peaks are located in the fluctuation index (step 1820). For example, as FIGS. 18C illustrates, the fluctuation index at the 7^{th} row is the highest, which is the center of pupil of FIGS. 18A and 18B.

Pupil Index

Among the selected maxima points, one point in a block is chosen using a Pupil Index (PI) (step 1825), which measures horizontal and vertical changes of pupil signal. Horizontal PI is measured by the slope and height for both left and right side of peak as follows in Equation (4):
Horizontal PI=(Left Slope*Left Height(hl))²*(Right Slope* Right Height(hr))² (4)
, where Slope is measured by hl/wl for left side and hr/wr for right side. FIG. 19 illustrates example locations for measurements for horizontal pupil index (PI).

Vertical PI is obtained by a pixel value relative to upper and lower neighbors. It is measured by 5 directional slits, s, and then, multiplied by weight vector, w, as follows in Equation (5):

$${s}_{i} = \frac{k}{{\sum }_{j}^{} {p}_{ij}} , Vertical PI = {\prod }_{i = 1}^{5} ( {s}_{i} * {w}_{i} ) , \qquad ( 5 )$$

, where sᵢ is the ith slit, pᵢ is the jth pixel belongs to ith slit, and k is the pixel value.

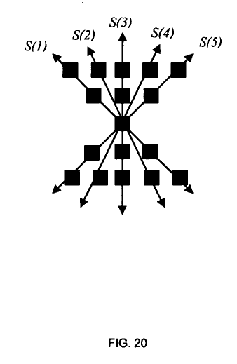

FIG. 20 is an illustrative example showing the slits for vertical PI. Subsequently, one point with maximum PI is selected as a pupil candidate in a block, where PI is calculated by multiplying both horizontal PI and vertical PI, as shown below in Equation (6):
Pupil Index=Horizontal PI*Vertical PI (6)

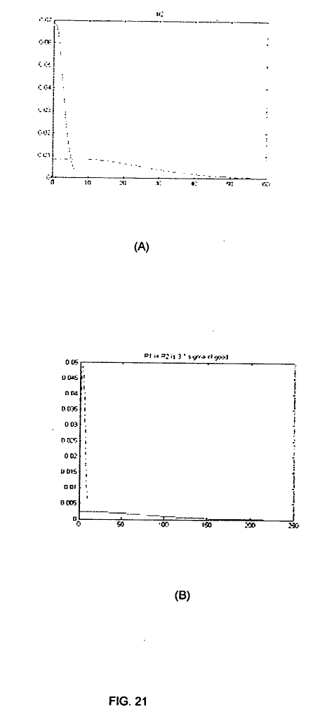

In FIG. 21, the horizontal PIs of 7 maxima are [0.6312, 0.1729, 1.0348, 0.1821, 0.1211, 0.6334, 0.2291]*1.0e+009 and Vertical PIs are [8.9281, 1.9421, 127.3418, 3.9435, 7.5034, 154.2741, 7.5696]. The resultant PI's are (maximum shown in boldface type): [0.0564, 0.0034, 1.3177, 0.0072, 0.0091, 0.9771, 0.0173]*1.0e+011. Therefore, the 2^{nd} maxima (10^{th} column) of 2^{nd} line (6^{th} line) is chosen to be the pupil candidates (step 1830).

Selecting Pupil

If there are more than two pupil candidates (step 1835), a selection scheme is employed, which uses Ratios of Pupil Index (step 1840). Those Ratios are calculated with three highest pupil indexes (x₁, x₂, x₃, where x₁≧x₂≧x₃) as follows in Equations (7), (8), and (9):

$$\begin{matrix}{1}^{st} Primary Ratio ( {R}_{11} ) = \frac{{x}_{1}}{{x}_{2}} = {y}_{1} & ( 7 ) \\ {2}^{nd} Primary Ratio ( {R}_{12} ) = \frac{{x}_{2}}{{x}_{3}} = {y}_{2} & ( 8 ) \\ Secondary Ratio ( {R}_{2} ) = \frac{{y}_{1}}{{y}_{2}} & ( 9 )\end{matrix}$$

Secondary Ratio (R₂) represents the distance between top two pupils and the third. If the value of x₁ and x₂ are close and significantly larger than x₃, R₂ is very small. For example, the solid red line in FIG. 21A shows Gaussian probability density function of R₂ (0.3752, 2.8) in the situation where x₁ and x₂ are the “real” pupils, while the dotted blue line in FIG. 21A represents PDF of R₂ when neither x₁ or x₂ is pupil. This indicates that there is a high probability that both x₁ and x₂ are real pupils if R₂ is small.

A Primary Ratio represents the distance between x₁ and x₂ (R₁₁) or x₂ and x₃ (R₁₂). If R₁₁ is significantly large, x₁ is most likely a pupil. For example, FIG. 21B shows Gaussian PDF of R₁₁ on the overlapped area in FIG. 21B. Extremely high R₁₁ was obtained in the case where both pupils (solid red line) were found; while false pupils have low R₁₁ (dotted blue line). R₁₂ is used for further processing to select the second pupil after x₁ is selected.

I have found that the above examples indicate that pupil(s) may be selected by utilizing Ratios of Pupil Index with predefined thresholds if the ratios are outstanding.

For example, for the image of FIGS. 20A-20D, the three Pupil Indexes and ratios that were obtained in each block are as follows.
Pupil Index=[1.3177, 0.8366, 0.0014]*1.0e+011
R₁=[1.5750, 607.1132]
R₂=0.0026

Based on the fact that R₂ is extremely small and R₁₁ is small, it was very easy to pick two pupils—in fact, those are real pupils.

In the situation where the Pupil Index Ratios are not clear to distinguish two pupils (step 1845), this embodiment of the invention employs one geometrical rule (step 1850): this rule states that pupil candidates are separated by the column center of cropped image. With this rule, pupil candidates are divided into two groups (left and right). A candidate with highest pupil index at each side is then selected as a pupil (step 1850).

Implementation Results

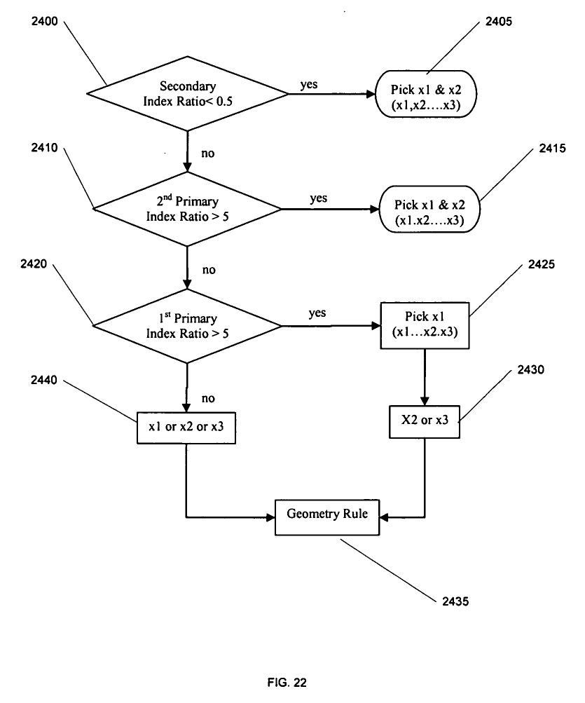

The method mentioned above was tested with 987 highly jpeg compressed facial images. The threshold of R₁₁, R₁₂, and R₂ were heuristically chosen with 5, 5, and 0.5 respectively. In one embodiment, the pupil selection flow was as shown in FIG. 17. In one embodiment, the pupil selection flow was as shown in FIG. 22.

My results showed that both pupils were found with 95.2% accuracy for non eye-glass facial images (i.e., faces where individuals not wearing eye glasses). In my testing, I was successful in locating pupils for 677 out of 711 images. I did find, in some instances, that pupil detection was less successful for images where individuals are wearing eye glasses. Pupil detection is designed in such a way to utilize the characteristics of pupil. If a person wears eye-glasses, I have found that white spots caused by reflection of light on glass or frame may cover a pupil or act like a pupil. In addition, I have found that tinted eye-glasses can weaken the pupil signal. However, I expressly contemplate that the systems and methods I describe in my co-pending, commonly assigned patent application entitled “Detecting Skin, Eye Region, and Pupils in the Presence of Eyeglasses,” Ser. No. 60/514,395, filed Oct. 23, 2004, which is hereby incorporated by reference, can be combined with the teachings of the present invention to further address these issues.

I also expressly contemplate that the invention I describe herein can be combined with many different types of technologies, including technologies that implement, for example:
A filter to remove vertically long edges that are shown in borders;
A filter to remove hairs that generates large standard deviations;
Further processing of the vertical profile to eliminate false peaks;
Investigation of other chrominance components;
Development of a process for providing Confidence Level derived by Pupil Index;
Development of a Method for calculating optimized thresholds of Pupil Index; and/or
Development of an eye glass detection method.

The favorable results I have achieved shows that my proposed systems and methods can have many uses, as will be appreciated by those of skill in the art. For example, this result clearly indicates the proposed method can be used for capturing pupils for identification card (ID) or other secure document applications. This result also indicates that the proposed method has applicability in many different biometric systems (especially that require accurate location of eyes and/or pupils), including facial recognition and/or facial authentication systems, security systems, etc.

Computer Systems for Implementing Embodiments of the Invention

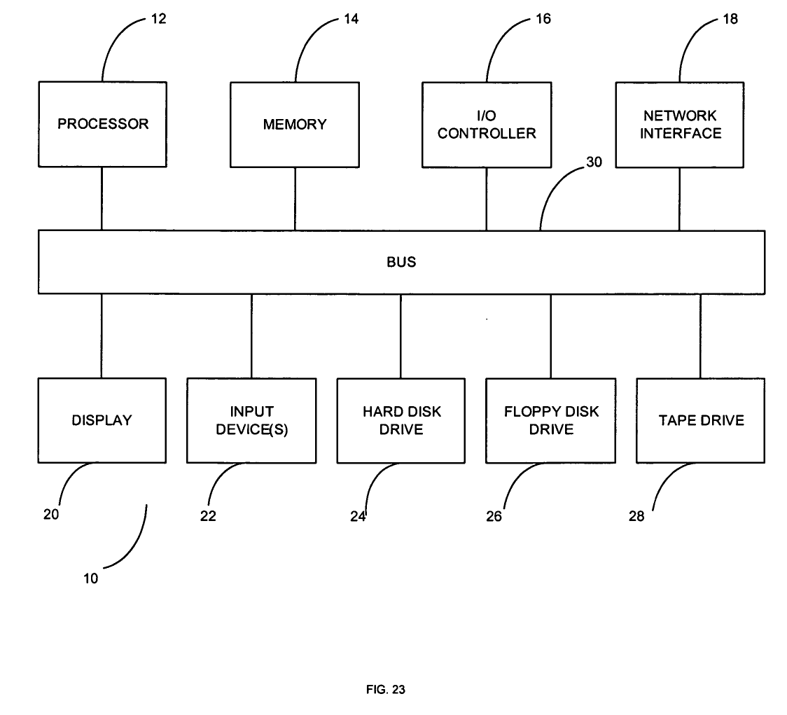

Systems and methods in accordance with the invention can be implemented using any type of general purpose computer system, such as a personal computer (PC), laptop computer, server, workstation, personal digital assistant (PDA), mobile communications device, interconnected group of general purpose computers, and the like, running any one of a variety of operating systems. An example of a general-purpose computer system 10 usable with at least one embodiment of the invention is illustrated in FIG. 23

Referring briefly to FIG. 23, the general purpose computer system 10 includes a central processor 12, associated memory 14 for storing programs and/or data, an input/output controller 16, a network interface 18, a display device 20, one or more input devices 22, a fixed or hard disk drive unit 24, a floppy disk drive unit 26, a tape drive unit 28, and a data bus 30 coupling these components to allow communication therebetween.

The central processor 12 can be any type of microprocessor, such as a PENTIUM processor, made by Intel of Santa Clara, Calif. The display device 20 can be any type of display, such as a liquid crystal display (LCD), cathode ray tube display (CRT), light emitting diode (LED), and the like, capable of displaying, in whole or in part, the outputs generated in accordance with the systems and methods of the invention. The input device 22 can be any type of device capable of providing the inputs described herein, such as keyboards, numeric keypads, touch screens, pointing devices, switches, styluses, and light pens. The network interface 18 can be any type of a device, card, adapter, or connector that provides the computer system 10 with network access to a computer or other device, such as a printer. In one embodiment of the present invention, the network interface 18 enables the computer system 10 to connect to a computer network such as the Internet.

Those skilled in the art will appreciate that computer systems embodying the present invention need not include every element shown in FIG. 23, and that equivalents to each of the elements are intended to be included within the spirit and scope of the invention. For example, the computer system 10 need not include the tape drive 28, and may include other types of drives, such as compact disk read-only memory (CD-ROM) drives. CD-ROM drives can, for example, be used to store some or all of the databases described herein.

In at least one embodiment of the invention, one or more computer programs define the operational capabilities of the computer system 10. These programs can be loaded into the computer system 10 in many ways, such as via the hard disk drive 24, the floppy disk drive 26, the tape drive 28, or the network interface 18. Alternatively, the programs can reside in a permanent memory portion (e.g., a read-only-memory (ROM)) chip) of the main memory 14. In another embodiment, the computer system 9 can include specially designed, dedicated, hard-wired electronic circuits that perform all functions described herein without the need for instructions from computer programs.

In at least one embodiment of the present invention, the computer system 10 is networked to other devices, such as in a client-server or peer to peer system. The computer system 10 can, for example, be a client system, a server system, or a peer system. In one embodiment, the invention is implemented at the server side and receives and responds to requests from a client, such as a reader application running on a user computer.

The client can be any entity, such as a the computer system 10, or specific components thereof (e.g., terminal, personal computer, mainframe computer, workstation, hand-held device, electronic book, personal digital assistant, peripheral, etc.), or a software program running on a computer directly or indirectly connected or connectable in any known or later-developed manner to any type of computer network, such as the Internet. For example, a representative client is a personal computer that is x86-, PowerPC.RTM., PENTIUM-based, or RISC-based, that includes an operating system such as IBM.RTM, LINUX, OS/2.RTM. or MICROSOFT WINDOWS (made by Microsoft Corporation of Redmond, Wash.) and that includes a Web browser, such as MICROSOFT INTERNET EXPLORER, NETSCAPE NAVIGATOR (made by Netscape Corporation, Mountain View, Calif.), having a Java Virtual Machine (JVM) and support for application plug-ins or helper applications. A client may also be a notebook computer, a handheld computing device (e.g., a PDA), an Internet appliance, a telephone, an electronic reader device, or any other such device connectable to the computer network.

The server can be any entity, such as the computer system 10, a computer platform, an adjunct to a computer or platform, or any component thereof, such as a program that can respond to requests from a client. Of course, a “client” can be broadly construed to mean one who requests or gets the file, and “server” can be broadly construed to be the entity that sends or forwards the file. The server also may include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, active server pages, server side include (SSI) functions and the like.

In addition, software embodying the present invention, in one embodiment, resides in an application running on the computer system 10. In at least one embodiment, the present invention is embodied in a computer-readable program medium usable with the general purpose computer system 10. In at least one embodiment, the present invention is embodied in a data structure stored on a computer or a computer-readable program medium. In addition, in one embodiment, the present invention is embodied in a transmission medium, such as one or more carrier wave signals transmitted between the computer system 10 and another entity, such as another computer system, a server, a wireless network, etc. The present invention also, in an embodiment, is embodied in an application programming interface (API) or a user interface. In addition, the present invention, in one embodiment, is embodied in a data structure.

Concluding Remarks

In describing the embodiments of the invention and in illustrating it in the figures and examples, specific terminology is used for the sake of clarity. However, the invention is not limited to the specific terms so selected, and each specific term at least includes all technical and functional equivalents that operate in a similar manner to accomplish a similar purpose. The drawings are not necessarily to scale, emphasis instead generally being placed upon illustrating the principles of the invention.

As those skilled in the art will recognize, the invention described herein can be modified to accommodate and/or comply with many different technologies and standards. In addition, variations, modifications, and other implementations of what is described herein can occur to those of ordinary skill in the art without departing from the spirit and the scope of the invention as claimed. Further, virtually any aspect of the embodiments of the invention described herein can be implemented using software, hardware, or in a combination of hardware and software.

It should be understood that, in the Figures of this application, in some instances, a plurality of system elements or method steps may be shown as illustrative of a particular system element, and a single system element or method step may be shown as illustrative of a plurality of a particular systems elements or method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the total number of elements or steps shown for a particular system element or method is not intended to be limiting; those skilled in the art will recognize that the number of a particular system element or method steps can, in some instances, be selected to accommodate the particular user needs.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed.

1. A method for detecting a human face in an image, comprising:
detecting at least a portion of the skin of the human face in the image;
defining an eye region within the portion of the detected skin; and
locating the pupils of the eyes within the eye region.

2. The method of claim 1 wherein the image comprises a plurality of pixels and wherein the detection of skin employs a plurality of Gaussian skin models.

3. The method of claim 2, wherein each Gaussian skin model detecting a respective number of skin pixels in the image.

4. The method of claim 2 wherein each Gaussian skin model is associated with a respective range of skin tones.

5. The method of claim 4 further comprising selecting the Gaussian skin model that detects the largest number of skin pixels in the image to be the detected skin.

6. The method of claim 5 further comprising masking the R channel with the number of skin pixels detected in the image.

7. The method of claim 6, further comprising comparing each of the masked R channel pixels of claim 6 to a threshold, whereby if the masked R channel pixel is greater than the threshold the pixel is kept as detected skin and if the masked R channel pixel is less than the threshold the pixel is removed from the detected skin.

8. The method of claim 7 wherein the threshold comprises a predetermined threshold.

9. The method of claim 7 wherein the threshold is computed based on the average of the masked R channel pixels.

10. The method of claim 7 wherein the threshold is computed based on information in the image.

11. The method of claim 1, wherein the image comprises a plurality of pixels and wherein defining the eye region further comprises selecting an upper portion of the detected skin pixels.

12. The method of claim 11 further comprising locating coarse eye locations within the upper portion.

13. The method of claim 12 wherein locating coarse eye locations further comprises:
determining a first horizontal eye location; and
computing a vertical eye location based at least in part on the horizontal eye location.

14. The method of claim 12, wherein locating coarse eye locations further comprises:
providing horizontal profiles based on a standard deviation map;
adding deviation values horizontally;
locating the peak values in the horizontally added deviation values to determine horizontal eye locations.

15. The method of claim 12, wherein locating coarse eye locations further comprises:
providing vertical profiles based on a standard deviation map;
adding deviation values vertically;
applying modifications to the vertically added deviation values based on the size of the band and the width/height ration of an eye; and
replacing horizontal eye locations with a pixel having the highest average value within a small block.

16. The method of claim 1, wherein the image comprises a plurality of pixels and where the method further comprises:
receiving at least one eye location;
defining a block of pixels substantially centered on the at least one eye location, the block of pixels having a plurality of horizontal lines of pixels; and
calculating, for each horizontal line in the block, a fluctuation index measuring the fluctuation between adjacent pixels and signal strength.

17. The method of claim 16, further comprising:
calculating a pupil index (PI) at each peak on each horizontal line having a high fluctuation index; and
selecting a point within the block having maximum PI as a pupil location.

18. The method of claim 17, wherein calculating a pupil index further comprises measuring at least one of a set of pupil characteristics comprising at least one of slope, height, and pixel value relative to upper and lower neighbors.

19. The method of claim 18, further comprising employing a pupil selection process if there are more than two pupil locations in a block.

20. The method of claim 19 wherein the pupil selection process uses a ratio of pupils index.

21. The method of claim 19 wherein the pupil selection process uses at least one geometric rule.

22. A method of creating an image capable of being printed to an identification document, comprising:
capturing a digitized image of a subject;
locating a human face within the digitized image by:
detecting at least a portion of the skin of the human face in the image;
defining an eye region within the portion of the detected skin; and
locating the pupils of the eyes within the eye region; and
determining, based upon the face location, how the human face should be positioned and sized within the digital image.

23. The method of claim 22, further comprising generating instructions for a printer to be able to produce an identification document containing a photographic image of the face of the subject, wherein the subject's face is of a consistent size and position in the photographic image.

24. The method of claim 22, further comprising:
using the location of the pupils to create a biometric template based on the digitized image;
searching a biometric database using the biometric template;
determining, based on the search of the biometric template, whether any images are a substantial match to the digitized image.

25. A system for locating the eyes in a digital image that contains an image of a face, comprising:
a plurality of Gaussian models constructed and arranged to each detect at least one pixel in the digital image associated with a respective skin tone;
a selection subsystem selecting the Gaussian model that detected the most skin pixels to represent the skin in the digital image;
a cropping subsystem selecting a sub-portion of the digital image believed to contain the eyes;
means for determining candidates for horizontal eye locations in the sub-portion;
means for determining candidates for vertical eye locations in the sub-portion; and
means for selecting at least one eye location from the candidates for horizontal eye locations and the candidates for vertical eye locations.

26. The system of claim 25 wherein the digital image comprises at least two color channels and where selection subsystem further comprises means for employing at least one color channel in the image to refine the detected skin pixels.
